(19) United States
(12) Patent Application Publication
(10) Pub. No.: US 2001/0004066 A1
(43) Pub. Date: Jun. 21, 2001

(54) Substrate processing method and substrate processing apparatus

(75) Inventors: Takayuki Toshima, Nirasaki-Shi (JP); Takehiko Orii, Nirasaki-Shi (JP)

Correspondence Address: MORRISON & FOERSTER LLP, 555 West Fifth Street, Suite 3500, Los Angeles, CA, 90013-1024, US

(73) Assignee: TOKYO ELECTRON LIMITED OF JAPAN

(21) Appl. No.: 09/738,436

(22) Filed: Dec. 15, 2000

(30) Foreign Application Priority Data
Dec. 16, 1999 (JP) 1999-357599

(51) Int. Cl. H01B 13/00

(52) U.S. Cl. 216/13

(57) ABSTRACT

The present invention is a substrate processing method for etching a substrate having a wiring layer, an insulating layer, and a resist layer provided on the surface to form a contact hole in the insulating layer, and removing the resist layer and a polymer layer adhered to at least the surface of the contact hole from the substrate after etching. The substrate processing method includes a first step of making the surfaces 6 of the resist layer 3 and the polymer layer 5 existing on the substrate W hydrophilic. In a second step, the resist layer and polymer layer are removed by a processing liquid thereafter.

### BACKGROUND OF THE INVENTION

1. Field of the Invention

The present invention relates to a substrate processing method and a substrate processing apparatus for, for example, etching a substrate such as a semiconductor wafer and then removing a resist layer and a polymer layer existing on the substrate.

2. Description of the Prior Art

In the manufacturing process of a semiconductor device, a wiring layer and an inter-layer insulating layer are formed on a semiconductor wafer which is a substrate to be processed, and then a resist layer is formed on them, and a resist pattern is formed by the photolithographic art, and an insulating layer formed on the semiconductor wafer according to the pattern is dry-etched using a resist as a mask, and a contact hole reaching the wiring layer which is a lower layer is formed. Thereafter, the resist mask is removed by plasma ashing and the remaining resist mask and the polymer layer which is etching residues in the hole are removed by a processing liquid composed of inorganic and organic solvents.

However, when, as mentioned above, the plasma ashing is performed and then the remaining resist mask and polymer layer in the hole are to be removed by a processing liquid, it takes about 10 to 20 minutes and the total processing time is made longer. Further, two or more kinds of processing liquids are necessary for such liquid processing after plasma aching and the processing is made complicated.

### SUMMARY OF THE INVENTION

The present invention was developed with the foregoing in view and is intended to provide a substrate processing method and a substrate processing apparatus for removing a resist layer and a polymer layer from a substrate after etching in a short time without being accompanied by a complicated process.

The inventors of the present invention examined the reason for necessity of a prolonged and complicated process to remove the remaining resist mask and polymer layer in the hole by a processing liquid as mentioned above and found that it is caused by a damage layer formed on the surfaces of the resist layer and polymer layer by etching. Namely, we found that such an etching damage layer is a rigid layer deteriorated by plasma which cannot be removed by ashing and it is also a hydrophobic layer containing a lot of F⁺, so that it can be hardly removed even by a subsequent removal process using a processing liquid.

The present invention was developed on the basis of the aforementioned knowledge and the first characteristic of the present invention is that a substrate processing method for etching a substrate on which a wiring layer, an insulating layer, and a resist layer are provided to form a contact hole in the insulating layer, and removing the resist layer and a polymer layer adhered to at least the surface of the contact hole from the substrate after etching includes a first step of making the surfaces of the resist layer and polymer layer existing on the substrate hydrophilic and a second step of removing the resist layer and polymer layer by a processing liquid thereafter.

The second characteristic of the present invention is that a substrate processing apparatus for etching a substrate on which a wiring layer, an insulating layer, and a resist layer are provided to form a contact hole in the insulating layer, and removing the resist layer and a polymer layer adhered to at least the surface of the contact hole from the substrate after etching includes a gas feeder for feeding gas or ozone so as to make the surfaces of the resist layer and polymer layer formed on the substrate hydrophilic and a liquid process device for removing the resist layer and polymer layer whose surfaces are made hydrophilic by a processing liquid.

When the surfaces of the resist layer and polymer layer on which an etching damage layer as mentioned above is formed are modified to hydrophilic nature like this, the etching damage layer can be removed by the subsequent process using a processing liquid without difficulty. Therefore, the resist layer and polymer layer can be removed from the substrate after etching in a short time without being accompanied by a complicated process.

According to the aforementioned first and second characteristics of the present invention, when the surfaces of the resist layer and polymer layer are reacted with oxygen, the surfaces of the resist layer and polymer layer can be made hydrophilic.

As such a process, a process of reacting the surfaces of the resist layer and polymer layer on oxygen plasma may be cited. Such a process by oxygen plasma can be performed by a plasma ashing device. In this process, it is desirable to heat a substrate within the range from 130° C. to 150° C. beforehand.

As a process of reacting the surfaces of the resist layer and polymer layer on oxygen, a process of reacting the surfaces of the resist layer and polymer layer on oxygen excited by photon energy may be cited. Concretely, a process by ozone generated by exciting oxygen by photon energy is explained as an example. Namely, when O₂ gas is irradiated with, for example, ultraviolet light, ozone can be generated. However, ozone can be fed by another method.

Furthermore, when the resist layer and polymer layer are to be removed by a processing liquid, the processing liquid can be selected from hydrofluoric acid (HF), sulfuric acid (H₂SO₄), and organic solvent.

The third characteristic of the present invention is that a substrate processing apparatus for etching a substrate on which a wiring layer, an insulating layer, and a resist layer are provided to form a contact hole in the insulating layer, and removing the resist layer and a polymer layer adhered to at least the surface of the contact hole from the substrate after etching includes an ashing device for removing the resist layer formed on the substrate and a liquid process device for removing residues of the resist layer left unremoved by the ashing device and the polymer layer by a processing liquid, wherein the surfaces of the resist layer and polymer layer on the substrate are made hydrophilic by the ashing device.

By use of such a constitution, by the ashing device conventionally used, for example, a plasma ashing device, a part of the resist layer is removed and the surfaces of the resist layer and polymer layer on which an etching damage layer is formed are modified to hydrophilic nature, so that the etching damage layer can be removed by a processing liquid of the liquid process device without difficulty and residues of the resist layer and the polymer layer can be removed quickly. Therefore, the processing time of the liquid process device can be reduced remarkably and the resist layer and polymer layer can be removed from the substrate after etching in a short time without being accompanied by a complicated process. Since the processing time of the liquid process device can be shortened like this, the continuous wafer processing by the ashing device and liquid process device which is conventionally hard to be performed is made possible.

### BRIEF DESCRIPTION OF THE DRAWINGS

FIG. 1 is a cross sectional view for schematically explaining the steps of the substrate processing method relating to the present invention.

FIG. 2 is a cross sectional view showing a plasma ashing device for making the surfaces of a resist layer and a polymer layer hydrophilic.

FIG. 3 is a graph showing the contact angle of the surfaces of a resist layer and a polymer layer at each processing temperature when the O₂ gas flow rate and foaming gas flow rate during ashing processing are fixed and the CF₄ gas flow rate is changed.

FIG. 4 is a cross sectional view showing a liquid processor for performing a liquid process after the surfaces of a resist layer and a polymer layer are made hydrophilic.

FIG. 5 is a plan view schematically showing a system that a single-wafer processing type plasma ashing device and a single-wafer processing type liquid processor are integrated.

FIG. 6 is a schematic view showing another means for making the surfaces of a resist layer and a polymer layer hydrophilic.

### DESCRIPTION OF THE PREFERRED EMBODIMENTS

The embodiments of the present invention will be explained concretely hereunder with reference to the accompanying drawings.

Here, a process of removing a resist layer and a polymer layer after etching when a semiconductor wafer (hereinafter referred to as just a wafer) is used as a substrate.

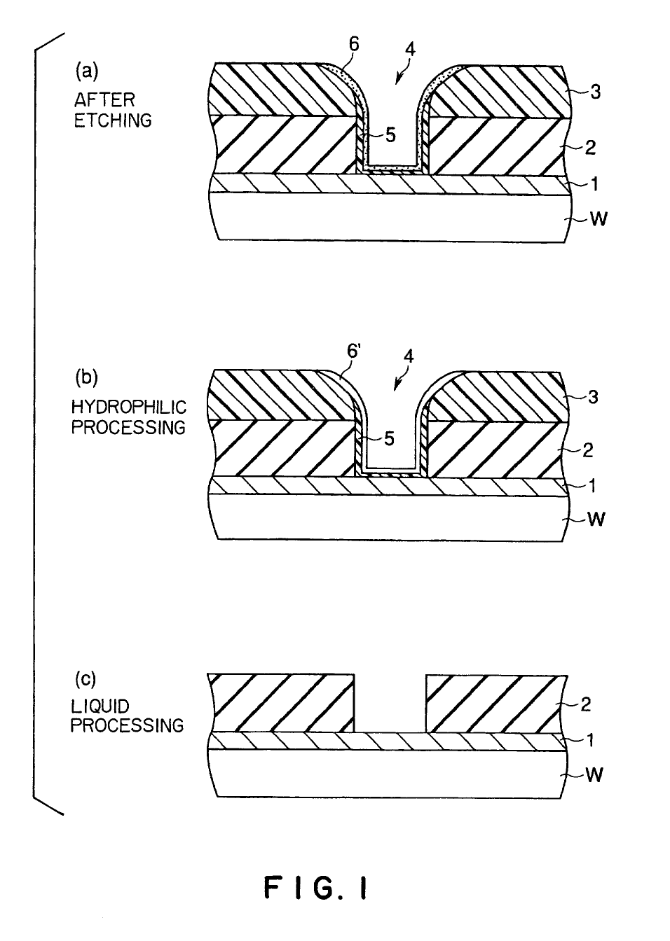

The etching process, as shown in FIG. 1(a) for example, is performed after a wiring layer 1 and an insulating layer 2 are formed on a wafer W, and then a resist layer 3 is formed, and a resist pattern is formed by the photographic art. By this etching process, a contact hole 4 reaching the wiring layer 1 is formed in the insulating layer 2. A polymer layer 5 is formed in the contact hole 4 by this etching. In this case, the polymer layer 5 is extended from the insulating layer 2 to the resist layer 3.

Immediately after etching, as shown in FIG. 1(a), an etching damage layer 6 is formed on the surfaces of the resist layer 3 and the polymer layer 5. The etching damage layer 6 is a rigid layer deteriorated by plasma during etching and is a hydrophobic layer containing a lot of F⁺. As a result, the etching damage layer 6 is little removed by the conventional plasma ashing process and hardly removed by the subsequent chemical solution processing. Therefore, in the conventional plasma ashing process, to remove residues of the resist layer 3 and the polymer layer 5 by the liquid processing, two kinds of processing liquids are necessary and complicated and further. Even if the two kinds of processing liquids are used like this, a long period of time such as 10 to 20 minutes is required. Therefore, according to the present invention, as shown in FIG. 1(b), the etching damage layer 6 is modified to a hydrophilic modified layer 6′. As a method for modifying the etching damage layer 6 to the hydrophilic modified layer 6′ like this, a method for reacting the surfaces of the resist layer 3 and the polymer 5 with oxygen may be used.

Thereafter, as shown in FIG. 1(c), the resist layer 3 and the polymer layer 5 are removed by a processing liquid. However, since the etching damage layer 6 is modified to the hydrophilic modified layer 6′, the modified layer 6′ is easily removed by the processing liquid. Therefore, the resist layer 3 and the polymer layer 5 can be removed in a short time such as within 2 minutes and moreover without being accompanied by a complicated process using two kinds of processing liquids.

As a process of reacting the surfaces of the resist layer 3 and the polymer layer 5 on oxygen as mentioned above, a process of reacting the surfaces of the resist layer 3 and the polymer layer 5 with oxygen plasma may be used, and the process by oxygen plasma can be performed by the single-wafer processing type plasma ashing device conventionally used.

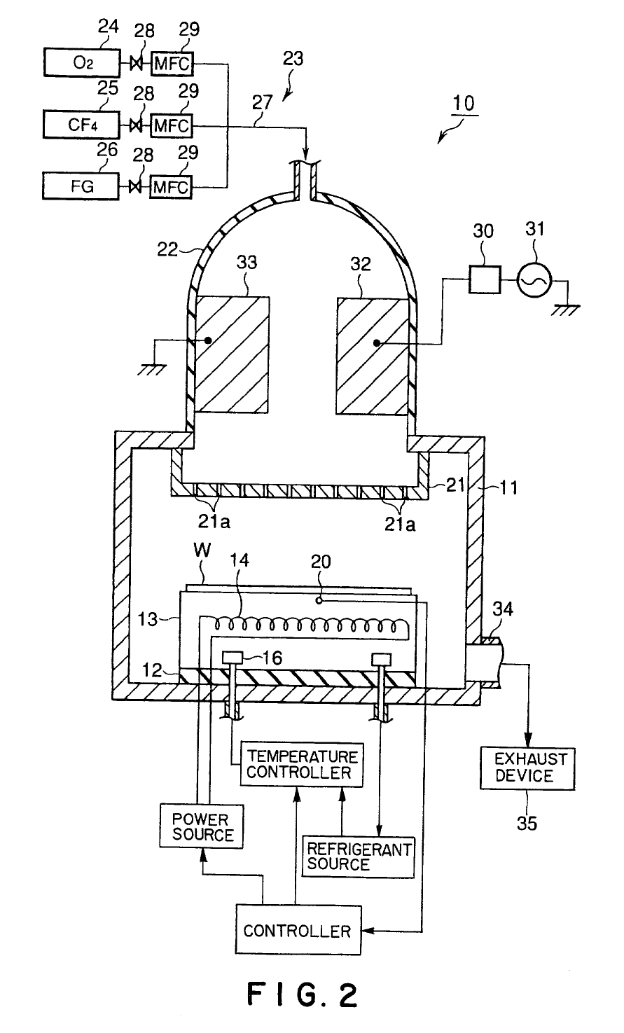

The single-wafer processing type plasma ashing device is so structured, for example, as shown in FIG. 2. The plasma ashing device 10 has a chamber 11, in which a substantially cylindrical wafer loading table 13 for loading the wafer W is installed at the bottom via an insulating plate 12 such as ceramics.

Inside the wafer loading table 13, a heater 14 is provided and a power source 15 is connected to the heater 14. A refrigerant flow path 16 is installed under the heater 14 in the wafer loading table 13 and a refrigerant in a refrigerant source 17 is circulated through the refrigerant flow path 16 by a pump not shown in the drawing. The temperature of the refrigerant can be controlled by a temperature controller 18. A controller 19 is connected to the power source 15 and the temperature controller 18. In the vicinity of the top of the wafer loading table 13, a temperature sensor 20 such as a thermocouple is provided, and the temperature of the wafer W can be measured indirectly by the temperature sensor 20. A detection signal of the sensor 20 is sent to the controller 19. The controller 19 transmits a control signal to the power source 15 and the temperature controller 18 on the basis of the detection signal and therefore can control the temperature of the wafer W indirectly.

Right above the wafer loading table 13, a shower head (gas feeder) 21 is installed opposite to the wafer loading table 13. The shower head 21 is supported by the upper part of the chamber 11 and many gas discharge holes 21a are formed in the bottom of the shower head 21.

Above the chamber 11, a plasma chamber 22 is installed and a gas feed system 23 is connected to the top of the plasma chamber 22. The gas feed system 23 has an O₂ gas feed source 24, a CF₄ gas feed source 25, and a foaming gas (FG) feed source 26. O₂ gas, CF₄ gas, and foaming gas are fed to the plasma chamber 22 from the sources via a pipe 27. A valve 28 and a mass flow controller 29 are installed on each pipes connected to the O₂ gas feed source 24, the CF₄ gas feed source 25, and the foaming gas (FG) feed source 26. During an ashing process, the flow rate is controlled so that processing gas including O₂ gas mainly is fed to the plasma chamber 22.

In the plasma chamber 22, a pair of electrodes 32 and 33 are horizontally arranged opposite to each other. A high frequency power source 31 is connected to the one electrode 32 via an impedance matching box 30, and high frequency power is applied to the electrode 32 from the high frequency power source 31. A high frequency electric field is then formed between the electrodes 32 and 33, and gas passing between the electrodes is changed to plasma by the high frequency electric field, and oxygen plasma mainly including O₂ gas is formed. This oxygen plasma is fed to the wafer W on the loading table 13 via the shower head 21.

An exhaust pipe 34 is connected to the bottom of the chamber 11 and an exhaust device 35 is connected to the exhaust pipe 34. The exhaust device 35 has a vacuum pump such as a turbo molecular pump so that the chamber is evacuated to a predetermined vacuum atmosphere.

In the plasma ashing device 10 structured like this, the wafer W is loaded on the wafer loading table 13 first and suck by an appropriate suction means. Then, the chamber 11 is evacuated to a predetermined degree of vacuum by the exhaust device 35.

Thereafter, O₂ gas, CF₄ gas, and foaming gas are fed from the O₂ gas feed source 24, the CF₄ gas feed source 25, and the foaming gas (FG) feed source 26 of the gas feed system 23 to the plasma chamber 22 via the pipe 27 at a predetermined flow rate including mainly O₂ gas and these gases are discharged to the wafer W from the gas discharge holes 21a of the shower head 21. In this case, the inner pressure of the chamber 11 is kept at a predetermined value by the exhaust device 35.

At this time, high frequency waves are applied to the electrode 32 of the plasma chamber 22 from the high frequency power source 31, and processing gas including mainly O₂ gas passing between the electrodes is changed to plasma, and oxygen plasma is formed. The oxygen plasma is discharged to the wafer W via the shower head 21, and then the ashing process is performed for the wafer W. The wafer temperature in this case is controlled by the controller 19 on the basis of the detection value of the temperature sensor 20.

The surfaces of the resist layer 3 and the polymer layer 5 are reacted on oxygen by this ashing process and made hydrophilic, so that it is desirable to heat the wafer in the range from 130 to 150° C. and perform the ashing process.

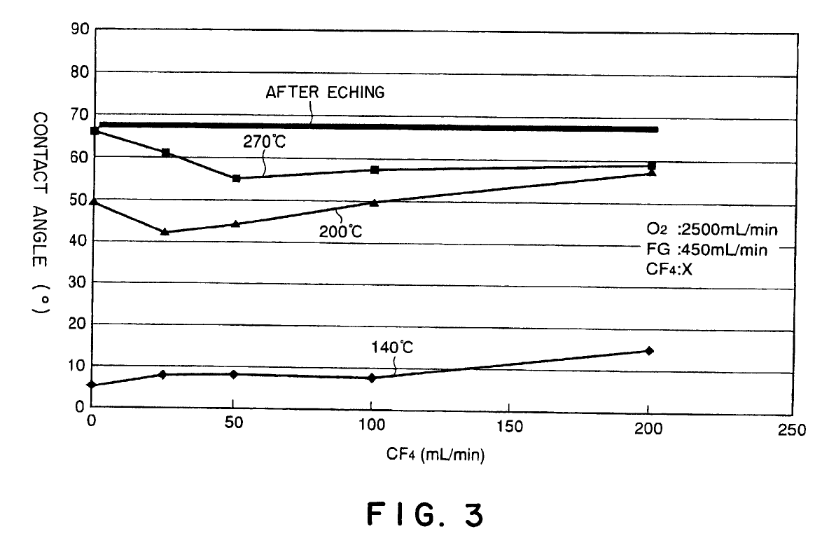

FIG. 3 is a graph showing a contact angle (angle of contact) at each processing temperature when the O₂ gas flow rate and foaming gas flow rate during ashing processing are fixed and the CF₄ gas flow rate is changed. Immediately after ashing, it shows that the contact angle of the surfaces of the resist layer 3 and the polymer layer 5 is about 70° and the surfaces are still hydrophobic. The conventional ashing process is performed at a wafer temperature of about 270° C. In this case, the contact angle of the surfaces of the resist layer 3 and the polymer layer 5 is in the range from 60 to 70° and the surfaces are kept hydrophobic. When the wafer temperature is decreased to 200° C., the contact angle is reduced slightly, though the contact angle is 50 to 60° and it cannot be said that the surfaces are made hydrophilic. When the ashing process is performed at 140° C. within the desirable range, it is ascertained that the contact angle of the surfaces of the resist layer 3 and the polymer layer 5 is in the range from 5 to 15° and the surfaces are sufficiently hydrophilic. The ashing process at this temperature produces a low effect in removal of the resist layer 3. However, since the etching damage layer 6 is made hydrophilic, the resist layer 3 and others can be removed extremely quickly by the subsequent liquid processing.

After such an ashing process, the resist layer 3 and the polymer layer 5 are removed by the processing liquid. However, as mentioned above, the etching damage layer 6 is made hydrophilic and hence the processing time using the processing liquid can be shortened remarkably such as within 2 minutes, so that a single-wafer processing type processing liquid device can be used.

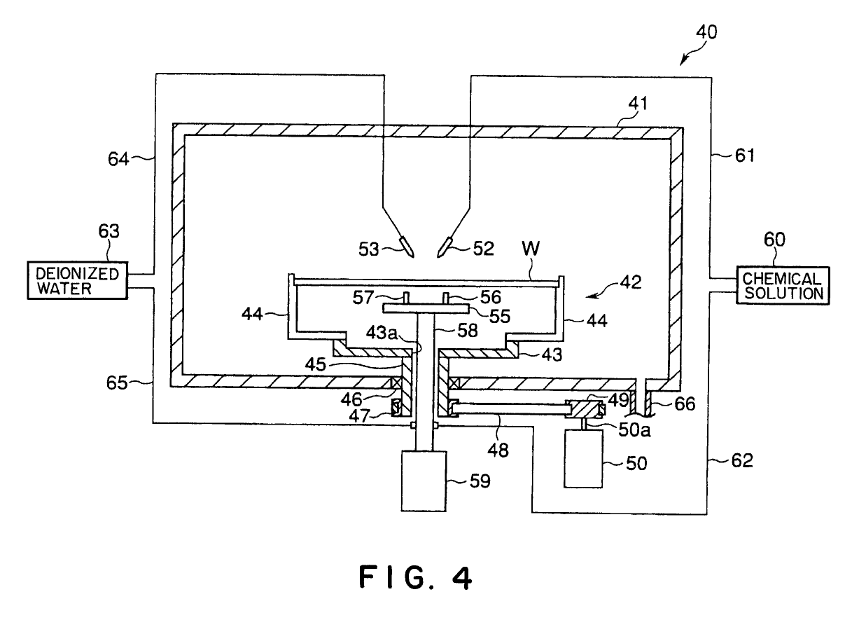

The single-wafer processing type liquid processor is structured, for example, as shown in FIG. 4. A liquid processor (liquid process device) 40 has a chamber 41, in which a holding mechanism 42 for holding the wafer W horizontally from the outside so as to rotate is installed. The holding mechanism 42 has a rotary member 43 installed so as to rotate and a plurality of holding members 44 for holding the periphery of the wafer W, which are radially extended from the rotary member 43. A cylindrical member 45 extending downward is attached to the central part of the bottom of the rotary member 43. A pulley 47 is fit into the bottom of the cylindrical member 45 and a belt 48 is wound round the pulley 47. The belt 48 is also wound round a pulley 49 attached to a shaft 50a of a motor 50. Therefore, the rotary member 43 is rotated by belt drive via the cylindrical member 45, and the wafer W held by the holding members 44 is also rotated in association with it.

A chemical solution discharge nozzle 52 is provided above the wafer W for discharging a chemical solution for removing residues of the resist layer 3 on the wafer W and the polymer layer 5. The chemical solution is selected from, for example, hydrofluoric acid (HF), sulfuric acid (H₂SO₄), and organic solvent, is applied onto the top of the wafer W. A deionized water nozzle 53 is provided for discharging deionized water for the subsequent rinsing onto the top of the wafer W.

On the other hand, under the wafer W, a chemical solution discharge nozzle 56 for discharging a chemical solution onto the rear of the wafer W and a deionized water discharge nozzle 57 for discharging deionized water are installed in a state that they are supported by a support member 55. The support member 55 is supported by an elevating shaft 58 and the elevating shaft 58 extends to an air cylinder 59 installed downward through a hole 43a formed at the center of the rotary member 43 and the cylindrical member 45. Therefore, the support member 55 is structured so as to move up and down via the shaft 58 by the air cylinder 59.

A chemical solution is fed to the chemical solution nozzles 52 and 56 via pipes 61 and 62 respective from a chemical solution feed source 60. Deionized water is fed to the deionized water nozzles 53 and 57 via pipes 64 and 65 respectively from a deionized water feed source 63. A chemical solution from the pipe 62 and deionized water from the pipe 65 are fed to the nozzles 56 and 57 respectively via the paths installed in the elevating shaft 58. At the bottom of the chamber 41, a drain boat 66 is installed.

In the liquid processor 40 structured like this, the wafer W is held by the holding mechanism 42, and the rotary member 43 is rotated by the motor 50 via the belt 48 and the cylindrical member 45, and the wafer W held by the holding mechanism 42 is rotated. At the same time, a predetermined chemical solution is discharged onto the top (front surface) of the wafer W via the pipe 61 and the chemical solution feed nozzle 52 from the chemical solution feed source 60. By doing this, the chemical solution is spread overall the wafer W during rotation and residues of the resist layer 3 on the wafer W and the polymer layer 5 are removed. A chemical solution is also fed to the bottom of the wafer W via the pipe 62 and the nozzle 56 from the chemical solution feed source 60 and the bottom of the wafer W, so that, the rear surface of the water is cleaned. In this case, as mentioned above, removal of residues of the resist layer 3 and the polymer layer 5 can be carried out by one kind of chemical solution in a very short time such as within 2 minutes because the etching damage layer of the surfaces thereof is modified to hydrophilic nature.

After the processing using a chemical solution is finished, deionized water is discharged onto the front surface of the wafer W via the pipe 64 and the deionized water nozzle 53 from the deionized water feed source 63 in the state that the wafer W is rotating, and deionized water is discharged onto the rear surface of the wafer W via the pipe 65 and the deionized water nozzle 57. In this manner, the rinsing process is performed for the wafer W.

Thereafter, the wafer W is rotated at high speed by the motor 50 and dried by scattering deionized water adhered to the wafer W and a series of liquid processing is finished.

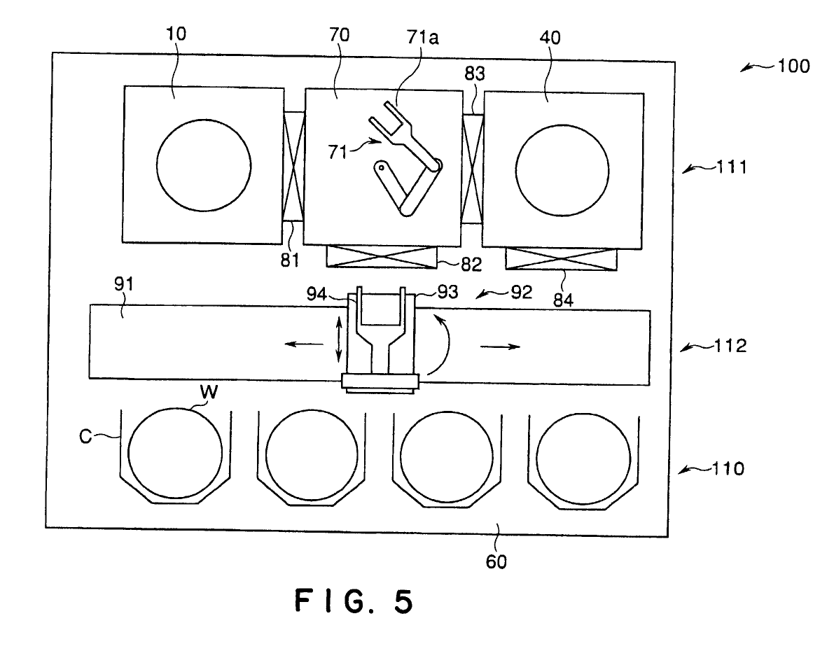

In order to perform the process of the plasma ashing device 10 and the process of the liquid processor 40 continuously, a processing system as schematically shown in FIG. 5 may be used.

The processing system 100 has a taking-in and -out station 110 for taking in and out the wafer W, a processing station 111 for executing the ashing process and liquid process, and a transfer station 112 for transferring the wafer W between the taking-in and out station 110 and the processing station 111.

The taking-in and out station 110 has a loading table 60 which can support four carriers C holding a plurality of wafers. A carrier C holding wafers W before processing is taken in the lording table 60 and the carrier C loading wafers W after processing is taken out therefrom.

In the processing station 111, the plasma ashing device 10 and the liquid processor 40 are arranged and a load lock chamber 70 is arranged between them. In the load lock chamber 70, a transfer device, for example, a multi-joint arm 71 for transferring the wafer W is arranged. The multi-joint arm 71 has a hand 71a at its top and the wafer W is loaded on the hand 71a. The multi-joint arm 71 receives the wafer W from the transfer station 112 and transfers the wafer W to and from the ashing device 10 and the liquid processor 40. The load lock chamber 70 has a gate valve 81 installed between the ashing device 10 and the load lock chamber 70, a gate valve 82 installed between the transfer station 112 and the load lock chamber 70, and a gate valve 83 installed between the liquid processor 40 and the load back chamber 70 and transfers the wafer W via the gate valves. The load lock chamber 70 is constructed so as to connect the plasma ashing device 10 which is a vacuum device and the liquid processor 40 which is a normal pressure device. When the wafer W is to be transferred with the ashing device 10, the load lock chamber 70 is set in a predetermined vacuum state, and when the wafer W is to be transferred with the transfer station 112 and the liquid processor 40, the load lock chamber 70 is set in the normal pressure state. A gate valve 84 is installed between the liquid processor 40 and the transfer station 112.

The transfer station 112 has a transfer path 91 installed along the arrangement direction of the carriers C of the taking-in and out station 110 and a transfer device 92 movable along the transfer path 91. The transfer device 92 has a body moving on the transfer path 91 which is not shown in the drawing, a base member 93 installed so as to elevate and rotate with respect to the body, and a wafer holding member 94 installed so as to move forward and backward with respect to the base member 93.

In the processing system 100 structured like this, one wafer W is taken out from any carrier C of the transfer station 110 by the transfer device 92 of the transfer station 112. The multi-joint arm 71 of the load lock chamber 70 receives the wafer W loaded on the wafer holding member 94 of the transfer device 92. Thereafter, the gate valve 82 is closed, the load lock chamber 70 is evacuated, the gate valve 81 is opened, and the wafer W is taken into the plasma ashing device 10.

After the ashing process is finished, the gate valve 81 is opened, the wafer W is taken out from the ashing device 10 by the multi-joint arm 71, the gate valve 81 is closed, and then the inside pressure of the load lock chamber 70 is returned to the normal pressure.

Thereafter, the gate valve 83 is opened, the wafer W is transferred to the liquid processor 40 by the multi-joint arm 71, and the liquid processing is performed. After the liquid processing is finished, the gate valve 84 is opened, the wafer W is received by the wafer holding member 94 of the transfer device 92 of the transfer station 112, and the wafer W is taken into any carrier C of the taking-in and -out station. This process is performed for a predetermined number of wafers W and the process is completed.

Conventionally, the liquid processing after ashing requires a long period of time such as 10 to 20 minutes, so that devices of different types such as a single-wafer processing type ashing device and a batch type liquid processor are necessary and the throughput is not sufficient. However, as mentioned above, the liquid processing of the present invention can be performed in a short time such as less than 2 minutes, so that both the ashing process and liquid process can be performed continuously like this by a single-wafer processing type device and sufficient throughput can be obtained.

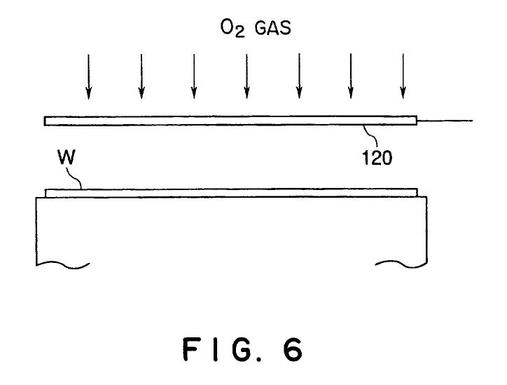

The present invention is not limited to the aforementioned embodiment and many variations are available. In the aforementioned embodiment, the plasma ashing device is used as a reaction process on oxygen so as to make the etching damage layer hydrophilic. However, the present invention is not limited to it and for example, as shown in FIG. 6, it is possible to feed ozone generated by exciting, for example, O₂ gas by photon energy such as an ultraviolet lamp 120 to the wafer W. Such a process can be performed, for example, using a conventional ozone ashing device. When ozone generated by exciting oxygen is to be used, ozone may not be generated by photon energy. The process of making the etching damage layer hydrophilic may not be limited to the reaction process with oxygen. Furthermore, an example that a single-wafer processing type device is used as a liquid processor is indicated above. However, the present invention is not limited to and a batch type device may be used. The chemical solution for liquid processing is not limited to the aforementioned. Furthermore, in the aforementioned embodiment, a case that the present invention is applied to a semiconductor wafer as a substrate to be processed is indicated. However, the present invention is not limited to the semiconductor water and can be applied also to other substrates to be processed such as a substrate for a liquid crystal display unit (LCD) and others.

As mentioned above, according to the present invention, when the surfaces of the resist layer and polymer layer where the etching damage layer is formed, are modified to hydrophilic nature beforehand, the etching damage layer can be removed by the subsequent process using a processing liquid without difficulty. Therefore, the resist layer and polymer layer can be removed from the substrate after etching in a short time without being accompanied by a complicated process.

According to the present invention, a part of the resist layer is removed and the surfaces of the resist layer and polymer layer where the etching damage layer is formed are modified to hydrophilic nature by the ashing device conventionally used, for example, the plasma ashing device. Therefore, the etching damage layer can be removed by the processing liquid of the liquid processor without difficulty and residues of the resist layer and the polymer layer can be removed quickly. Thus, the processing time of the liquid processor can be reduced remarkably and the resist layer and polymer layer can be removed from the substrate after etching in a short time without a complicated process. Further, since the processing time of the liquid processor can be shortened like this, the continuous single-wafer processing by the ashing device and liquid processor which has conventionally difficult, can be performed.

What is claimed is:

1. A substrate processing method for a substrate on which a wiring layer, an insulating layer, and a resist layer are provided, and removing said resist layer and a polymer layer adhered to at least a surface of a contact hole formed in said insulating layer, comprising:
a first step of making surfaces of said resist layer and said polymer layer existing on said substrate hydrophilic and
a second step of removing said resist layer and said polymer layer by a processing liquid thereafter.

2. The substrate processing method according to claim 1, wherein
said first step comprising reacting said surfaces of said resist layer and said polymer layer with oxygen.

3. The substrate processing method according to claim 2, wherein
said first step comprising reacting said surfaces of said resist layer and said polymer layer with oxygen plasma.

4. The substrate processing method according to claim 3, wherein
said first step by using oxygen plasma is performed by a plasma ashing device.

5. The substrate processing method according to claim 3, wherein
said first step by using oxygen plasma is performed by heating said substrate in a range from 130° C. to 150° C.

6. The substrate processing method according to claim 2, wherein
said first step comprising reacting said surfaces of said resist layer and said polymer layer with oxygen excited by photon energy.

7. The substrate processing method according to claim 1, wherein
said first step comprising reacting said surfaces of said resist layer and said polymer layer with ozone.

8. The substrate processing method according to claim 2, wherein
said processing liquid used in said second step is selected from hydrofluoric acid (HF), sulfuric acid (H₂SO₄), and organic solvent.

9. A substrate processing apparatus for a substrate on which a wiring layer, an insulating layer, and a resist layer are provided, and removing said resist layer and a polymer layer adhered to at least a surface of said contact hole formed in said insulating layer, comprising:
a gas feeder for feeding gas and processing said substrate so as to make surfaces of said resist layer and said polymer layer formed on said substrate hydrophilic and
a liquid process device for removing said resist layer and said polymer layer whose surfaces are made hydrophilic by a processing liquid.

10. The substrate processing apparatus according to claim 9, wherein
said gas is oxygen or ozone.

11. The substrate processing apparatus according to claim 10, wherein
said gas is oxygen plasma.

12. The substrate processing apparatus according to claim 10, wherein
said gas is oxygen excited by photon energy.

13. The substrate processing apparatus according to claims 9, wherein
said liquid process device removes said resist layer and said polymer layer which are hydrophilic, by a processing liquid selected from hydrofluoric acid (HF), sulfuric acid (H₂SO₄), and organic solvent.

14. A substrate processing apparatus for preparing a substrate on which a wiring layer, an insulating layer, and a resist layer are provided, and removing said resist layer and a polymer layer adhered to at least a surface of a contact hole formed in said insulating layer, comprising:
an ashing device for ashing said resist layer formed on said substrate and
a liquid process device for removing residues of said resist layer left unremoved by said ashing device and said polymer layer by a processing liquid,
wherein said surfaces of said resist layer and said polymer layer on said substrate are made hydrophilic by said ashing device.

15. The substrate processing apparatus according to claim 14, wherein
both said ashing device and said liquid process device are single-wafer processing type devices for processing substrates one by one, and said substrates are continuously processed by said devices.

16. The substrate processing apparatus according to claim 14, wherein
said ashing device has a heater for heating said substrates, and a controller for controlling the heater so that the temperature of said substrates is in the range from 130° C. to 150° C.

17. The substrate processing apparatus according to claim 15, further comprising a transfer device for transferring said substrates between said ashing device and said liquid process device.

18. The substrate processing apparatus according to claim 17, wherein
both said ashing device and said liquid process device are single-wafer processing type devices for processing substrate one by one, and said substrates are continuously processed by said devices.
